(19) United States
(12) Patent Application Publication
(10) Pub. No.: US 2008/0054588 A1
(43) Pub. Date: Mar. 6, 2008

(54) Pedal scooter

(76) Inventor: Jasper Lee Walker, Jersey City, NJ (US)

Correspondence Address: PAUL GAUER ATTORNEY, 347 FRANKLIN STREET, BLOOMFIELD, NJ, 07003, US

(21) Appl. No.: 11/511,905

(22) Filed: Aug. 29, 2006

(51) Int. Cl. B62M 1/00

(52) U.S. Cl. 280/221

(57) ABSTRACT

Disclosed is a pedal scooter for kids, adults, and physically challenged people who enjoy riding scooter for fun and exercise. The pedal scooter is light weight, simple in use, durable, and configured to be driven by two riders at the same time. The pedal scooter comprises: a platform; a seating arrangement coupled to the platform; a steering arrangement disposed on the platform, the steering arrangement enabling the pedal scooter to be maneuvered; and a drive mechanism configured to operationally propel the pedal scoter. The pedal scooter enables a first rider to sit on the seating arrangement, and propel the pedal scooter in a forward direction by operating the drive mechanism, and a second rider to stand on the platform and maneuver the pedal scooter in a desired direction using the steering arrangement.

### FIELD OF THE INVENTION

The present invention relates generally to scooters, and more particularly, to pedal scooters for kids, adults, and physically challenged people who enjoy riding scooter for fun and exercise.

### BACKGROUND OF THE INVENTION

Riding for fun and exercise is very popular among individuals of all ages and disabilities. To make the riding easy, safe, and more enjoyable among kids, adults, and physically challenged people, a wide variety of fuel-less riding systems, such as, scooters, bicycles, are suggested in the prior art. In recent years, scooter riding is one of the biggest fads among riding enthusiasts. Scooters appeal to both adults and children for their fun use and ability to be used as legitimate transport. However, one of the problems associated with one type of scooters is that the user must stand at all times and propel the unit with a foot. This can be tiring for the ride and can also cause user to become off-balance while riding. Typically, scooters are ridden by a single person at a time and cannot be used by two persons at once. Further, with the rise in consumer affluence, consumers are willing to pay a little more for the convenience, appearance, and dependability. But, the conventional riding systems neither appeal nor are convenient for portability and packaging purposes. Furthermore, the conventional riding systems are heavy, complex in use, and non-durable for years of effective use.

U.S. Pat. No. 4,852,898 teaches improvement in a pedal-operated polycycle including a hydraulic cylinder in fluid; pressure integral communication with piston means depending from such pedals; a hydraulic line in substantial co-alignment with the mainframe of the polycycle; an input of the hydraulic line being in communication with the hydraulic cylinder; and a rear wheel drive secured in rotational relationship with both an output of the hydraulic line and a tangent surface of the rear wheel of the polycycle. Riding is can be tiring for the ride and can also cause user to become off-balance while riding. The typical scooters are ride by a single person at a time and can not be used by two persons at once. This system is heavy, non-portable, and complex. It can not be used by two persons at once. Further it does not enable the user to ride in a standard manner and then switch to a seated riding style when desired.

U.S. Pat. No. 6,375,208 provides a combined skateboard scooter comprising a handlebar, a front body, a transmission device, a wheel device, and a board. A rear end of the front body is pivoted to the board and includes a slot through which a steering rod extends. The steering rod is attached to the handlebar to move therewith and movable along the slot. The transmission device is engaged with the steering rod and the wheel device such that back and forth movement of the steering rod urges the wheel device to move forward via transmission by the transmission device. The wheel device includes wheels attached to front and rear ends of the board. The user may stand on the board and operate the handlebar and the steering rod to move back and forth to thereby move the combined skateboard scooter forward. This system is heavy, not portable, and complex. It can not be used by two persons at once. Additionally, this can be tiring for the ride and can also cause the rider to become off-balance while riding.

U.S. Pat. No. 6,769,706 teaches a scooter having a steerable front wheel assembly, a rear wheel assembly and a frame linking the front and rear wheel assemblies. The scooter has a drive mechanism comprising front and back crankshafts rotatably attached to the frame and attached to left and right pedals. The front crankshaft transmits power to the rear wheel by means of a front sprocket gear, a continuous chain and a rear sprocket gear. This system is also complex. It can not be used by two persons at once. This can be tiring for the ride and can also cause rider to become off-balance while riding.

None of the prior arts particularly discuss a system that can be used by two persons at the same time, while making the riding ideal among individuals of all ages and disabilities. The conventional riding systems neither appeal nor are portable. Furthermore, the conventional riding systems are heavy, complex in use, non-durable for years of effective use.

Accordingly, there is a need for a lightweight, simple in use and durable riding system that can be used by two persons at the same time, while also providing easy, safe, and more enjoyable riding to kids, adults, and physically challenged people.

### SUMMARY OF THE INVENTION

In view of the foregoing disadvantages inherent in the prior arts, the general purpose of the present invention is to provide a pedal scooter for kids, adults, and physically challenged people who enjoy riding scooter for fun and exercise, to include all the advantages of the prior arts, and to overcome the above-mentioned disadvantages inherent therein.

In one aspect, the present invention provides a pedal scooter. The pedal scooter comprises: a platform; a seating arrangement coupled to the platform; a steering arrangement disposed on the platform, the steering arrangement enabling the pedal scooter to be maneuvered; and a drive mechanism configured to operationally propel the pedal scoter, wherein the pedal scooter enables a first rider to sit on the seating arrangement, and propel the pedal scooter in a forward direction by operating the drive mechanism, and a second rider to stand on the platform and maneuver the pedal scooter in a desired direction using the steering arrangement.

In another aspect, the present invention provides a drive mechanism for propelling a pedal scooter having a plurality of wheels. The drive mechanism comprises: a pedal; a front sprocket; a rear sprocket; a transmission member coupling the front sprocket and the rear sprocket, such that, the front sprocket and the rear sprocket conjointly move in a direction; a link connecting the pedal to the front sprocket; and a compressible member disposed between the pedal and the front sprocket, wherein upon application of pressure on the pedal, the pedal moves pivotally downwards causing the compressible member to compress, the front sprocket to rotate by a first rotation greater than or equal to about 180 degrees in a counter clockwise direction, enabling the rear sprocket to rotate by the first rotation in the counter clockwise direction, and the wheels coupled to the rear sprocket to rotate by the first rotation in the counter clockwise direction, thereby allowing the pedal scooter to move in a forward direction, and upon releasing the pressure from the pedal, the compressible member decompresses, causing the pedal to move pivotally upwards, the front sprocket to rotate by a second rotation greater than or equal to about 180 degrees in the counter-clockwise direction, enabling the rear sprocket to rotate by the second rotation in the counter clockwise direction, and the wheels coupled to the rear sprocket to rotate by the second rotation in the counter clockwise direction, causing a complete rotation of the wheels, allowing the pedal scooter to move in a forward direction.

In yet another aspect, the present invention provides a pedal scooter. The pedal scooter comprises: a platform having a front portion, a back portion, a top surface and a bottom surface; a wheel arrangement configured on the bottom surface of the platform, the wheel arrangement having front wheels, rear wheels, a front axle, a rear axle, and connectors; a seating arrangement configured on the top surface of the platform, towards the back portion, the seating arrangement having a seat, a seat support, a seat support enclosure, a base plate and base plate bars; a steering arrangement mounted on the top surface towards a front portion of the platform, the steering arrangement having a vertical pole, a handlebar, a hinge and a hinge support, the steering arrangement enabling the pedal scooter to be maneuvered; a braking arrangement having a hand brake, a brake cable and braking calipers, the braking arrangement configured to operationally decelerate the pedal scooter; and a drive mechanism having a pedal, a front sprocket, a rear sprocket, a transmission member, a link, and a compressible member, the drive mechanism configured to operationally propel the pedal scoter, wherein the pedal scooter enables a first rider to sit on the seating arrangement, and propel the pedal scooter in a forward direction by operating the drive mechanism, and a second rider to stand on the platform and maneuver the pedal scooter in a desired direction using the steering arrangement.

These together with other aspects of the present invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated exemplary embodiments of the invention.

### BRIEF DESCRIPTION OF THE DRAWINGS

The advantages and features of the present invention will become better understood with reference to the following more detailed description and claims taken in conjunction with the accompanying drawings, wherein, like elements are identified with like symbols, and in which:

FIG. 1 illustrates a perspective view of a pedal scooter 1000, according to an exemplary embodiment of the present invention;

FIG. 2 is a perspective view of the pedal scooter 1000 in a utilized state, according to an exemplary embodiment of the present invention;

FIG. 3 is a bottom view of the pedal scooter 1000 illustrating wheel assembly and braking arrangement, according to an exemplary embodiment of the present invention;

FIG. 4 illustrates a drive mechanism of the pedal scooter 1000, according to an exemplary embodiment of the present invention;

FIGS. 5A, 5B and 5C illustrates different positions of the drive mechanism of the pedal scooter 1000, according to an exemplary embodiment of the present invention;

FIG. 6A illustrates a lever 700 coupled to a pedal 600, according to another exemplary embodiment of the present invention;

FIG. 6B illustrates a lever receiving arrangement 710 disposed on a pedal 600, according to another exemplary embodiment of the present invention; and

FIG. 7 illustrates a perspective view of a pedal scooter 1000 in a utilized state having the lever 700 coupled to the pedal 600, according to another exemplary embodiment of the present invention.

Like reference numerals refer to like parts throughout several views of the drawings.

### DETAILED DESCRIPTION OF THE INVENTION

The exemplary embodiments described herein detail for illustrative purposes are subject to many variations in structure and design. It should be emphasized, however, that the present invention is not limited to a particular pedal scooter, as shown and described. It is understood that various omissions, substitutions of equivalents are contemplated as circumstances may suggest or render expedient, but is intended to cover the application or implementation without departing from the spirit or scope of the claims of the present invention.

The terms “a” and “an” herein do not denote a limitation of quantity, but rather denote the presence of at least one of the referenced item and the terms “first,” “second,” and the like, herein do not denote any order, quantity, or importance, but rather are used to distinguish one element from another.

The present invention provides a pedal scooter, for kids, adults and physically challenged (people with paralyzed limbs) for easy transportation and additionally, riding scooter for fun and exercise. The pedal scooter is designed in a simple way enabling riding the same standing as well as while seating in a comfortable manner. Additionally, the pedal scooter of the present invention allows two people, most likely children, to ride at a same time, making the ride easy and enjoyable. The pedal scooter of the present invention is lightweight, convenient for riding, safe, easy to use, durable, and at the same time inexpensive.

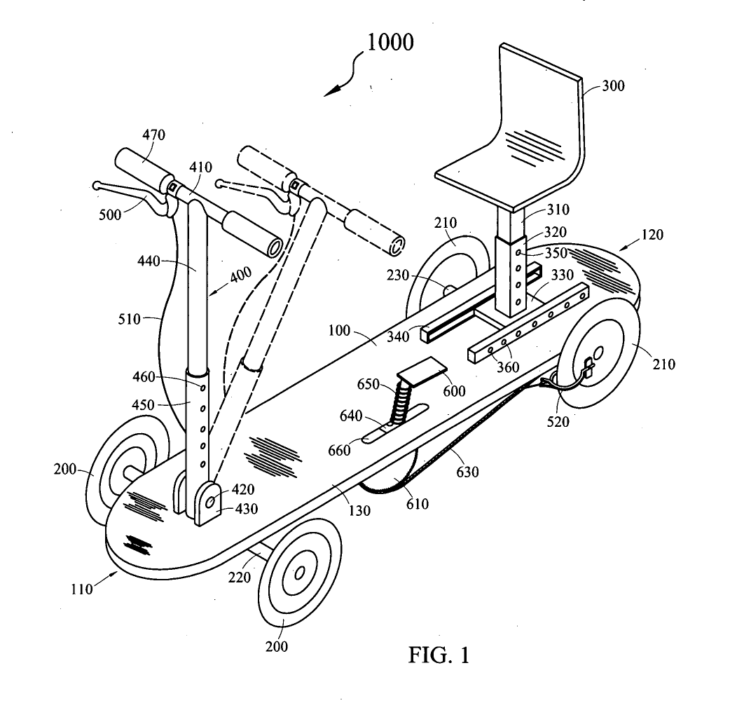

Referring to FIGS.1-7, a pedal scooter 1000 is shown. In an embodiment, the pedal scooter 1000 comprises a platform 100, a wheel arrangement, a seating arrangement, a steering arrangement, a braking arrangement and a drive mechanism.

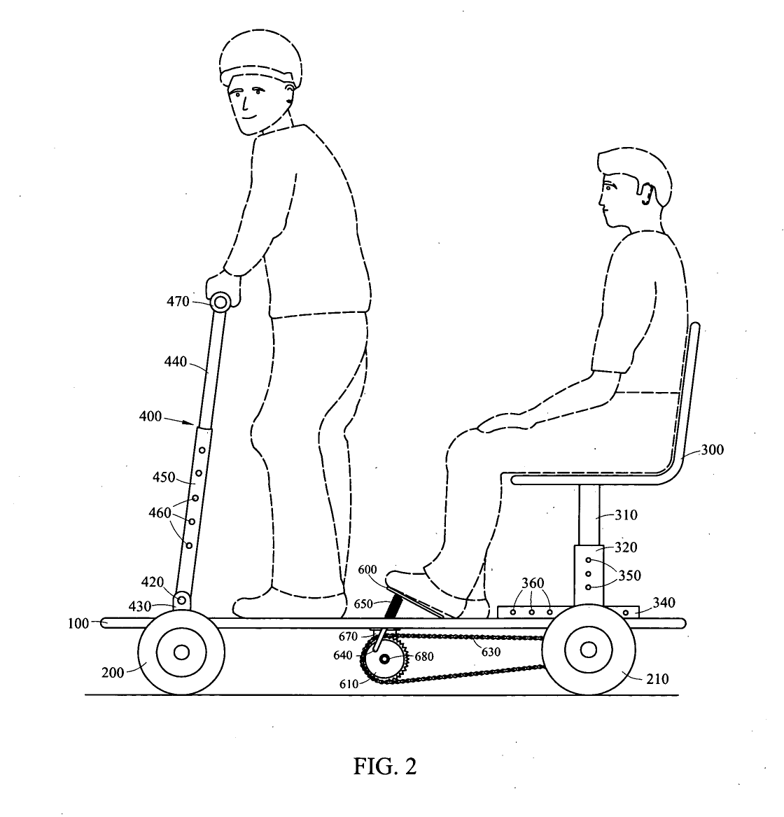

The platform 100 is an elongated structure comprising a front portion 110, a back portion 120, a top surface 130 and a bottom surface 140. On the top surface 130 of the platform 100 and towards the front portion 110, the steering arrangement is configured. The seating arrangement is configured on the top surface 130 of the platform 100, towards the back portion 120. The wheel arrangement is configured on the bottom surface 140 of the platform 100 and the drive mechanism protrudes from the front surface 130 towards the bottom surface 140. In one embodiment, the platform 100 is 4 feet long and 1 foot wide, providing enough space to accommodate two persons (most likely children) at a time in a utilized state (See FIG. 2). The material used in manufacturing the platform 100 may include durable plastic, and the like.

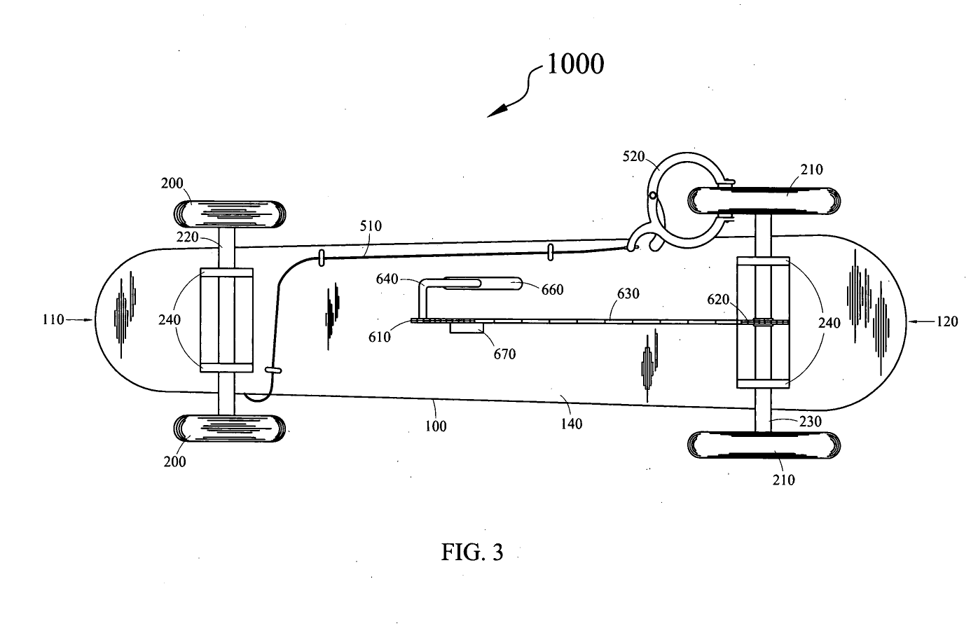

As illustrated in FIG. 3, the platform 100 is mounted on the wheel arrangement. The wheel arrangement includes a plurality of wheels (front wheels 200 and rear wheels 210), a front axle 220, a rear axle 230, connectors 240 and roller bearings (not shown). In one embodiment, the pedal scooter 1000 may have two front wheels 200 and two rear wheels 210. However, the wheel arrangement of the pedal scooter 1000 may have the front wheels 200 and the rear wheels 210 arranged in different combinations. The front wheels 200 are connected to each other by means of the front axle 220 at the bottom surface 140 of the front portion 110. The rear wheels 210 are connected to each other by means of the rear axle 230 at the bottom surface 140 of the back portion 120 of the platform 100. Connectors 240 are attached to the bottom surface 140 of the platform 100 and consist of roller bearings. The wheels 200, 210 may be made of durable material including hard plastic, rubber or the like materials providing long life to the wheels 200, 210.

The seating arrangement is mounted on the top surface 130 of the platform 100. In one embodiment, the seating arrangement may be disposed at approximately the half way point on the top surface 130 of the platform 100. Seating arrangement includes a seat 300, a seat support 310, a seat support enclosure 320, a base plate 330 and base plate bars 340. The seat 300 is permanently fixed to the seat support 310. The seat 300 may be produced from materials such as, lightweight plastic, and the like. The seat support 310 and the seat support enclosure 320 are coupled to each other in a manner, such that, the seat support 310 and the seat support enclosure 320 are arranged telescopically, allowing the seat support 310 to slidably move within the seat support enclosure 320. The seat support 310 and the seat support enclosure 320 are coupled together using fasteners 350 such as, screws, bolts, nuts, and the like. The height of the seat 300 may be adjusted at different levels by adjusting the position of the seat support 310 within the seat support enclosure 320 using the fasteners 350. The seat support enclosure 320 is coupled to the base plate 330. The base plate 330 is movably secured along a plurality of slots within the base plate bars 340, such that, the position of the seat 300 may be moved forward or backward along the base plate bars 340 by changing the position of the base plate 330 at different slots 360 of the base plate bars 340 and fastening the same.

The steering arrangement is mounted on the front portion 110 of the platform 100. The steering arrangement comprises a vertical pole 400, a handlebar 410, a hinge 420 and a hinge support 430. The vertical pole 400 comprising a steer bar. 440, and a steer bar enclosure 450, is configured to provide an adjustable height varying feature. The steer bar 440 and the steer bar enclosure 450 are coupled to each other in a manner, such that, the steer bar 440 and the steer bar enclosure 450 are arranged telescopically, enabling the steer bar 440 to slidably move within the steer bar enclosure 450, thereby providing adjustable height varying feature to the vertical pole 400. The steer bar 440 and the steer bar enclosure 450 are coupled using fasteners 460, such as, screws, bolts, nuts, and the like. The adjustable height varying feature of the vertical pole 400 enables riders of different height groups to drive the pedal scooter 1000 in a comfortable manner.

The steer bar enclosure 450 is connected to hinge 420 mounted on the front portion 110 of the top surface 130 of the platform 100 through a hinge support 430. The hinge support 430 enables the vertical pole 400 to move forward and backward at different positions along a length of the platform and perpendicular to a longitudinal axis of the hinge support 430, thereby allowing the rider to pull back the handle bar 410 while seated on the seat 300 and steer the pedal scooter 1000. The forward and backward positions of the vertical pole 400 is controlled using a locking mechanism (not shown) enabling the vertical pole 400 to have different fixed positions with respect to the platform 100.

Additionally, the handle bar 410 is equipped with hand grips 470 at two ends of the handle bar 410. Hand grips 470 provides proper grip to the rider while holding the handle bar 410, such that, the steering of the pedal scooter 1000 may be achieved by guiding the handle bar 410 in a desired direction of traveling.

In one embodiment, the braking arrangement includes hand brake 500, a brake cable 510 and braking calipers 520 (See FIGS. 1 and 3). The hand brake 500 is coupled to the handle bar 410. At one end, the brake cable 510 connects the hand brake 500 and travels along the vertical pole 400 and over the bottom surface 140 of the platform 100, such that, the brake cable 510 is secured along the vertical pole 400 and the bottom surface 140 of the platform 100 using suitable securing means such as clips, clamps, and the like. At the other end, the brake cable 510 connects the braking calipers 520. When the rider applies the brake by pulling the hand brake 500, the brake cable 510 attached to the hand brake 500 gets stretched, such that, the braking calipers 520 engages with at least one of the wheels thereby causing the pedal scooter 1000 to decelerate. In an embodiment, the braking calipers 520 engage with one of the rear wheels 210.

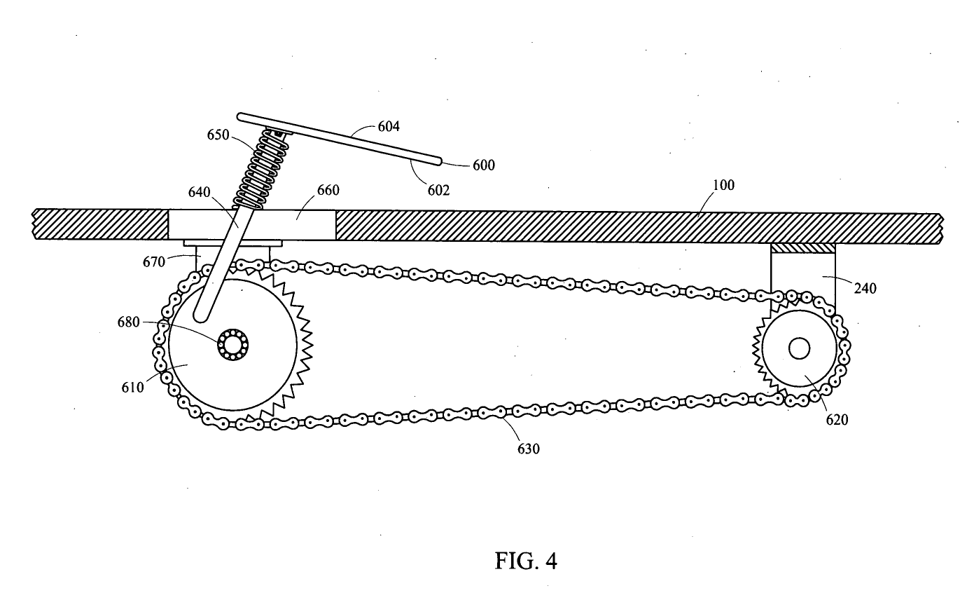

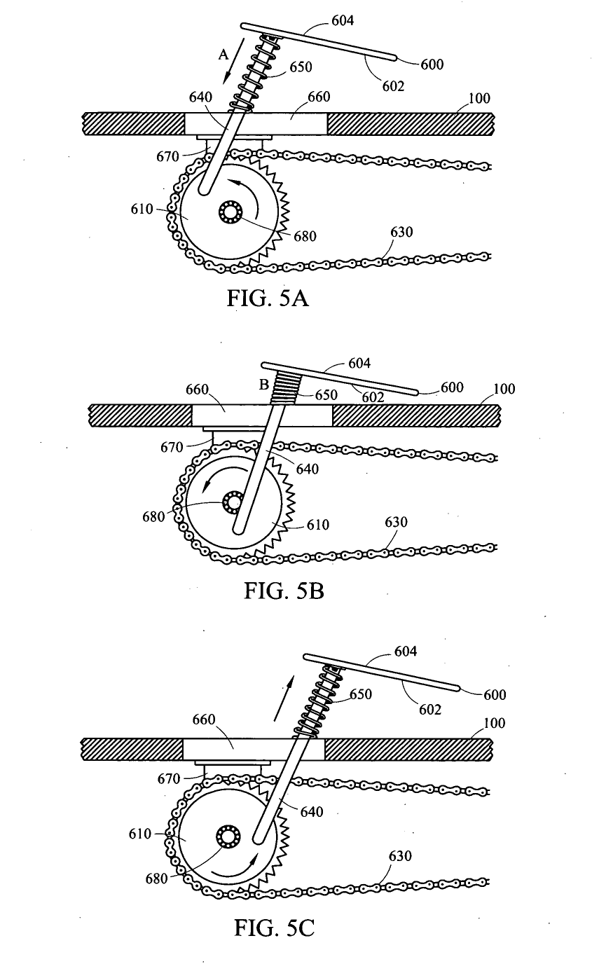

As shown in FIGS. 4, 5A through to 5C, illustrated is the drive mechanism. The drive mechanism comprises a pedal 600, a front sprocket 610, a rear sprocket 620, a transmission member 630, a link 640, a compressible member 650, and an opening 660. The front sprocket 610 and the rear sprocket 620 are coupled with the transmission member 630, such as, chain, and the like. The front sprocket 610 is connected to the bottom surface 140 of the platform 100 by means of a sprocket connector 670. The sprocket connector 670 has a small cylindrical projected portion (not shown) wherein roller bearings 680 of the front sprocket 610 are fixed, thereby allowing the front sprocket 610 to rotate about the axis of the roller bearing 680. The rear sprocket 620 is coupled with the rear axle 230, and further connected with the bottom surface 140 of the platform 100 by means of sprocket connector 670. Additionally, the link 640 is coupled at a first end to a side surface of the front sprocket 610 and at a second end to a bottom surface 602 of the pedal 600, such that, an application of pressure on the pedal 600, causes the link 640 to move downwards and the front sprocket 610 to rotate in a counter clockwise direction. The link 640 is positioned at an angle inclined towards the seating arrangement of the pedal scooter 1000 and additionally, the pedal 600 is inclined towards the seating arrangement of the pedal scooter 1000. The opening 660 disposed on the platform 100 enables the link 640 to slide along the opening 660 and along the length of the platform 100. In one embodiment, the compressible member 650 includes spring, disposed on a top surface 130 of the platform 100, such that, the link 640 runs through a length of the compressible member 650 and the compressible member 650 is disposed between the bottom surface 602 of the pedal 600 and the top surface 130 of the platform 100. Additionally, the diameter of the compressible member 650 is greater than a width of the opening 660.

Now referring to FIGS. 5A-5C, different positions of the drive mechanism during riding the pedal scooter 1000 is illustrated. Initially, when the pedal scooter 1000 is not in use (not driven), the compressible member 650, is in an uncompressed state ‘A’ (See FIG. 5A). Now, when the rider applies pressure on a top surface 604 of the inclined pedal 600, the link 640 moves pivotally downward causing the compressible member 650 to be compressed to state ‘B’ (See FIG. 5B). As the first end of the link 640 is connected to the side surface of the front sprocket 610, the downward movement of the link 640 causes the front sprocket 610 to rotate a first 180 degree in the counter clockwise direction. As the transmission member 630 couples the front sprocket 610 to the. rear sprocket 620, the 180 degree counter clockwise rotation of the front sprocket 610 causes the rear sprocket 620 to also rotate a first 180 degree in the counter clockwise direction, thereby allowing about half a rotation of the wheels in the counter clockwise direction causing the pedal scooter 1000 to move a certain distance forward. The compressible member 650 is now in a compressed state ‘B’. At this point, when the rider releases the pressure from the top surface 604 of the pedal 600, the compressible member 650 gradually releases tension by pushing back the pedal 600 to its original position i.e. the uncompressed state ‘A’ of the compressible member 650. This gradual movement of the compressible member 650, lifts the pedal 600 pivotally upwards, causing the front sprocket 610 to rotate a second 180 degree in anticlockwise direction, resulting in one complete rotation of front sprocket 610 (See FIG. 5C). This movement of the front sprocket 610 causes the rear sprocket 620 to rotate in a second 180 degree in anticlockwise direction, resulting in one complete rotation of rear wheels 210, thereby allowing the pedal scooter 1000 to move further in the forward direction. Accordingly, by constantly applying and releasing the pressure on the top surface 604 of the pedal 600, the pedal scooter 1000 may be moved in a forward direction over a desired distance.

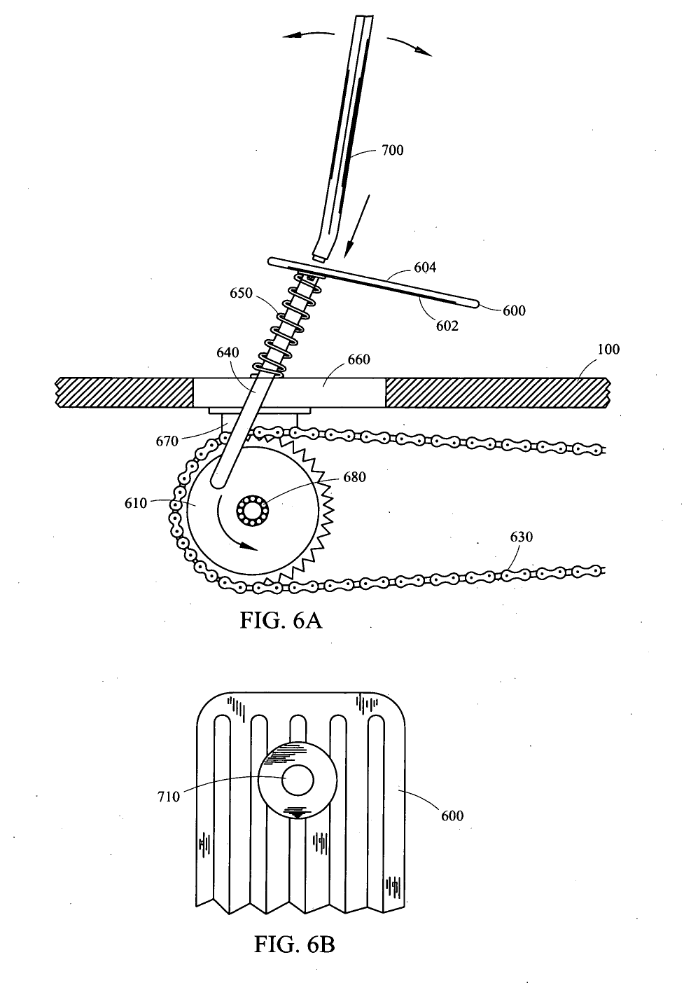

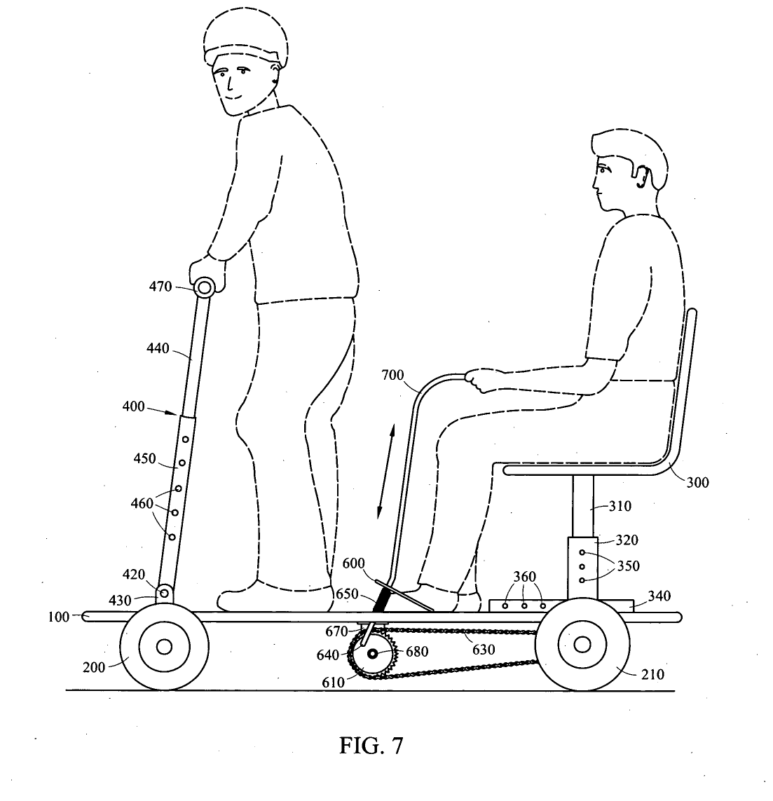

As shown in FIGS. 6A and 6B, a lever mechanism is configured by detachably engaging an elongated lever 700 to the link 640 through a lever receiving arrangement 710 on the pedal 600. The lever 700 may be secured within the lever receiving arrangement 710 using securing means such as screws, nut-bolts, threads, and the like. This lever mechanism enables riders to use their hands to drive the pedal scooter 1000 (See FIG. 7).

The platform 100, the seating arrangement, the steering arrangement, the braking arrangement, the wheel arrangement and the drive mechanism of the pedal scooter 1000 may be dismantled and packaged using a corrugated cardboard box and additionally, the packaging may include a pamphlet detailing instructions for assembling the pedal scooter. Further, cardboard inserts may be inserted into the package for protecting the dismantled pedal scooter. Additionally, the pedal scooter of the present invention may come in designs featuring different patters and colors that may appeal to all sections of the society.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby, enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

What is claimed is:

1. A pedal scooter, comprising:
a platform;
a seating arrangement coupled to the platform;
a steering arrangement disposed on the platform, the steering arrangement enabling the pedal scooter to be maneuvered; and
a drive mechanism configured to operationally propel the pedal scooter,
wherein the pedal scooter enables a first rider to sit on the seating arrangement, and propel the pedal scooter in a forward direction by operating the drive mechanism, and a second rider to stand on the platform and maneuver the pedal scooter in a desired direction using the steering arrangement.

2. The pedal scooter of claim 1, further comprising a braking arrangement configured to operationally decelerate the pedal scooter.

3. The pedal scooter of claim 1, further comprising a wheel arrangement operationally coupled with the drive mechanism, the wheel arrangement including a plurality of wheels enabled to move the pedal scooter.

4. The pedal scooter of claim 1, wherein the drive mechanism comprises a pedal, a front sprocket, a rear sprocket, a transmission member, a link, and a compressible member, and wherein
the front sprocket and the rear sprocket are coupled with the transmission member, such that the front sprocket and the rear sprocket conjointly move in a direction,
the link having a first end coupled to the front sprocket, and a second end coupled to the pedal, and
the compressible member disposed between the pedal and the platform, such that,
upon application of pressure on the pedal, the pedal moves pivotally downwards causing
the compressible member to compress,
the front sprocket to rotate in a counter clockwise direction, and
the pedal scooter to move in a forward direction, and
upon releasing the pressure from the pedal, the compressible member decompresses, causing
the pedal to move pivotally upwards,
the front sprocket to rotate in the counter-clockwise direction, and
the pedal scooter to move in the forward direction.

5. The pedal scooter of claim 1, further comprising a lever mechanism configured to detachably engage an elongated lever to the pedal, enabling a rider to use hands to apply pressure on the pedal.

6. The pedal scooter of claim 4, wherein the transmission member comprises a drive chain.

7. The pedal scooter of claim 4, wherein the compressible member comprises a spring.

8. A drive mechanism for propelling a pedal scooter having a plurality of wheels, comprising:
a pedal;
a front sprocket;
a rear sprocket;
a transmission member coupling the front sprocket and the rear sprocket, such that, the front sprocket and the rear sprocket conjointly move in a direction;
a link connecting the pedal to the front sprocket; and
a compressible member disposed between the pedal and the front sprocket,
wherein
upon application of pressure on the pedal, the pedal moves pivotally downwards causing
the compressible member to compress,
the front sprocket to rotate by a first rotation in a counter clockwise direction, enabling the rear sprocket to rotate by the first rotation in the counter clockwise direction, and
the wheels coupled to the rear sprocket to rotate by the first rotation in the counter clockwise direction, thereby allowing the pedal scooter to move in a forward direction,
upon releasing the pressure from the pedal, the compressible member decompresses, causing
the pedal to move pivotally upwards,
the front sprocket to rotate by a second rotation in the counter-clockwise direction, enabling the rear sprocket to rotate by the second rotation-in the counter clockwise direction, and
the wheels coupled to the rear sprocket to rotate by the second rotation in the counter clockwise direction,
thereby causing a complete rotation of the wheels and allowing the pedal scooter to move in the forward direction.

9. The drive mechanism of claim 8, wherein the transmission member comprises a drive chain.

10. The drive mechanism of claim 8, wherein the compressible member comprises a spring.

11. The drive mechanism of claim 8, further comprising a lever mechanism configured to detachably engage an elongated lever to the pedal, the lever enabling a rider to use hands to apply pressure on the pedal.

12. A pedal scooter comprising
a platform having a front portion, a back portion, a top surface and a bottom surface;
a wheel arrangement configured on the bottom surface of the platform, the wheel arrangement having front wheels, rear wheels, a front axle, a rear axle, and connectors;
a seating arrangement configured on the top surface of the platform, towards the back portion, the seating arrangement having a seat, a seat support, a seat support enclosure, a base plate and base plate bars;
a steering arrangement mounted on the top surface towards a front portion of the platform, the steering arrangement having a vertical pole, a handlebar, a hinge and a hinge support, the steering arrangement enabling the pedal scooter to be maneuvered;
a braking arrangement having a hand brake, a brake cable and braking calipers, the braking arrangement configured to operationally decelerate the pedal scooter; and
a drive mechanism having a pedal, a front sprocket, a rear sprocket, a transmission member, a link, and a compressible member, the drive mechanism configured to operationally propel the pedal scoter,
wherein the pedal scooter enables a first rider to sit on the seating arrangement, and propel the pedal scooter in a forward direction by operating the drive mechanism, and a second rider to stand on the platform and maneuver the pedal scooter in a desired direction using the steering arrangement.

13. The pedal scooter of claim 12, wherein
the seat support is coupled to the seat support enclosure in a manner, such that, the seat support is arranged telescopically with the seat support enclosure, allowing the seat support to slidably move within the seat support enclosure, thereby enabling the seat coupled to the seat support to be adjusted at different heights, and
the base plate is moveably secured along a plurality of slots within the base plate bars in a manner, such that, the position of the seat is moved forward and backward along the base plate bars by changing the position of the base plate coupled to the seat support enclosure at different slots of the base plate bars.

14. The pedal scooter of claim 12, wherein
the vertical pole comprises a steer bar coupled to the steer bar enclosure in a manner, such that, the steer bar and the steer bar enclosure are arranged telescopically, enabling the steer bar to slidably move within the steer bar enclosure, thereby providing an adjustable height varying feature to the steering arrangement, and
the hinge support coupled to the vertical pole enables the forward and backward movement of the vertical pole at different positions along a length of the platform, thereby allowing a rider to steer the pedal scooter while standing on the platform as well as while seated on the seat.

15. The pedal scooter of claim 12, wherein
the transmission member couples the front sprocket and the rear sprocket, in a manner, such that, the front sprocket and the rear sprocket conjointly move in a direction,
the link connects the pedal to the front sprocket through a opening in the platform, the link inclined at an angle towards the seating arrangement, and
the compressible member is disposed between the pedal and the front sprocket.

16. The pedal scooter of claim 16, wherein
upon application of pressure on the pedal, the pedal moves pivotally downwards causing
the compressible member to compress,
the front sprocket to rotate by a first rotation of greater than or equal to about 180 degrees in a counter clockwise direction, enabling the rear sprocket to rotate by the first rotation in the counter clockwise direction, and
the rear wheels coupled to the rear sprocket to rotate by the first rotation in the counter clockwise direction, allowing the pedal scooter to move in a forward direction,
upon releasing the pressure from the pedal, the compressible member decompresses, causing
the pedal to move pivotally upwards,
the front sprocket to rotate by a second rotation of greater than or equal to about 180 degrees in the counter-clockwise direction, enabling the rear sprocket to rotate by the second rotation in the counter clockwise direction, and
the rear wheels coupled to the rear sprocket to rotate by the second rotation in the counter clockwise direction,
thereby causing a complete rotation of the rear wheels and allowing the pedal scooter to move in the forward direction.

17. The pedal scooter of claim 12, wherein the transmission member comprises a drive chain.

18. The pedal scooter of claim 12, wherein the compressible member comprises a spring.

19. The pedal scooter of claim 12, further comprising a lever mechanism configured to detachably engage an elongated lever to the pedal, enabling a rider to use hands to apply pressure on the pedal.

20. The pedal scooter of claim 12, wherein the platform, the seating arrangement, the steering arrangement, the braking arrangement, the wheel arrangement and the drive mechanism is capable of being dismantled and packaged in a corrugated cardboard box.
